(19) United States
(12) Patent Application Publication
(10) Pub. No.: US 2007/0063503 A1
(43) Pub. Date: Mar. 22, 2007

(54) Device For Mounting A Module On The Steering Wheel Of A Motor Vehicle

(75) Inventors: Andreas Pradel, Berlin (DE); Marc Prost-Fin, Berlin (DE)

Correspondence Address: FITCH EVEN TABIN AND FLANNERY, 120 SOUTH LA SALLE STREET, SUITE 1600, CHICAGO, IL, 60603-3406, US

(73) Assignee: TAKATA-PETRI AG, Aschaffenburg (DE)

(21) Appl. No.: 11/468,173

(22) Filed: Aug. 29, 2006

Related U.S. Application Data
(63) Continuation of application No. PCT/DE05/00345, filed on Feb. 24, 2005.

(30) Foreign Application Priority Data
Mar. 1, 2004 (DE) 10 2004 010 469.7
Sep. 30, 2004 (DE) 10 2004 048 837.1

(51) Int. Cl. B62D 1/16

(52) U.S. Cl. 280/779

(57) ABSTRACT

A device for mounting a module on a turnable steering wheel of a motor vehicle is provided in such a manner that the angular position of the module remains constant when the steering wheel is turned. In one form, the device includes a reversing gearing with a first gearing element of the reversing gearing, which is attached to a part of the motor vehicle fixed to said vehicle; a second gearing element of the reversing gearing, which can be fixed to the module and can be turned together with the module, and; a gearing subassembly, which can be actuated by turning the steering wheel and via which the first gearing element is coupled with the second gearing element in such a manner that a turning of the steering wheel relative to the first gearing element along a turning direction is converted into a turning of the module connected to the second gearing element relative to the steering wheel in the opposite direction. The device also includes a first electrical contact unit, which is combined with the first gearing element to form a subassembly and is connected in a fixed manner to the part attached to the vehicle; a second electrical contact unit, which is combined with the second gearing element to form a subassembly and is connected to the module in a fixed manner, and; electrical connecting means for connecting the first electrical contact unit to the second electrical contact unit.

### CROSS REFERENCE TO RELATED APPLICATIONS

This is a continuation application of prior application number PCT/DE2005/000345, filed Feb. 24, 2005 and claims the benefit under 35 U.S.C. §119 of prior foreign application numbers DE 10 2004 010 469.7 and DE 10 2004 048 837.1, filed Mar. 1, 2004 and Sep. 30, 2004, respectively.

### FIELD OF THE INVENTION

The invention relates to a device for mounting a module on the steering wheel of a motor vehicle.

### BACKGROUND OF THE INVENTION

A device of this type serves to mount a module, in particular an airbag module, on a rotatable steering wheel of a motor vehicle in such a way that the angular position of the module remains constant if the steering wheel is rotated, in order to constantly ensure optimum, reproducible positioning of an inflatable airbag which can be deployed out of the module, for example in the case of a crash. The device has a gear mechanism, comprising a first gear mechanism element which is connected fixedly in terms of rotation, that is to say in terms of location, to a motor vehicle part which is mounted fixedly on the vehicle; a second gear mechanism element which is connected fixedly in terms of rotation to the module and can therefore be rotated jointly with the latter; and a gear mechanism assembly which can be actuated by rotation of the steering wheel and via which the first gear mechanism element is coupled to the second gear mechanism element in such a way that a rotation of the steering wheel relative to the stationary first gear mechanism element in any desired direction brings about a rotation of the module which is connected to the second gear mechanism element in the opposite direction. A device of this type is known from DE 26 25 184 A1 .

### SUMMARY OF THE INVENTION

The invention is based on the problem of providing a device of the type which is mentioned in the introduction, which device is distinguished by improved utilization of the available installation space and low integration expenditure when different assemblies are combined, compared with the known device.

According to the invention, this problem is solved by the features which are described hereinafter.

Accordingly, a first electrical contact unit is provided which is combined with the first gear mechanism element to form an assembly and, together with the latter, is connected fixedly to the part which is mounted fixedly on the vehicle, and a second electrical contact unit is provided which is combined with the second gear mechanism element to form an assembly and, together with the latter, is connected fixedly to the module, the two contact units being connected to one another via electrical connecting means.

Here, the assembly which comprises the first electrical contact unit and the first gear mechanism element and the assembly which comprises the second electrical contact unit and the second gear mechanism element are preferably configured as assemblies which can be preassembled completely outside the steering wheel and, in the finally assembled state, can be arranged on the module or a part which is mounted fixedly on the vehicle, in particular by integration (fixed connection) of the respective contact unit and the respective gear mechanism element.

In concrete terms, each of the two electrical contact units is preferably formed by a stator, a rotor which can be rotated (about the steering axis) with regard to the stator, and a flexible conductor which connects the stator to the rotor electrically, can be wound up and unwound with regard to the rotor/stator assembly and is called a flat spiral spring, as is known, for instance, from DE 196 16 234 A1 and DE 197 27 856 A1. Here, the stator of the first electrical contact unit is connected to the first gear mechanism element or integrally formed with the latter and is fixed together with the latter to a part which is mounted fixedly on the vehicle, and the stator of the second electrical contact unit is connected to the second gear mechanism element or integrally formed with the latter and is fixed together with the latter to the module, that is to say can be rotated jointly with the module with regard to the steering wheel. In contrast, the rotor of the respective contact unit is attached fixedly in terms of rotation to the steering wheel, that is to say can in each case be rotated jointly with the latter.

In one embodiment of the device according to the invention, the first gear mechanism element is configured as a first central gearwheel and the second gear mechanism element is configured as a second central gearwheel, in order to form a planetary gear mechanism. Here, the first gear mechanism element and the second gear mechanism element are preferably arranged coaxially with respect to the steering axis.

For coupling the first gear mechanism element to the second gear mechanism element, the gear mechanism assembly has a shaft which extends parallel to the steering axis, can be driven when the steering wheel is rotated and can be rotated about its longitudinal axis. If the first and second gear mechanism elements are configured as a first and a second central gearwheel, the first central gearwheel is coupled to the second central gearwheel via the shaft which extends parallel to the steering axis, in that a first peripheral gearwheel which is arranged at one end of the shaft engages into the first central gearwheel and a second peripheral gearwheel which is arranged on the other end of the shaft engages into the second central gearwheel. For this purpose, the shaft can be guided through an opening in the steering wheel basic body of the steering wheel.

If the steering wheel is rotated, the shaft which is guided through an opening in the steering wheel basic body of the steering wheel is driven in the rotational direction and the first peripheral gearwheel rolls on the first central gearwheel which is mounted fixedly on the vehicle. The rotational movement of the shaft about its axis which is produced by this is transmitted to the second central gearwheel by means of the second peripheral gearwheel which executes an identical movement (in the same direction) to the rotational movement of the first peripheral gearwheel, in such a way that the rotational movement of the second central gearwheel is in the opposite direction to the rotational movement of the peripheral gearwheels and thus also of the steering wheel (reversing gear mechanism). The result is that the module which is connected to the second central gearwheel is thus rotated in the opposite direction relative to the steering wheel, with the result that the angular position of the module remains constant in the fixed vehicle system of coordinates.

Here, the first and the second central gearwheels and the first and the second peripheral gearwheels are configured with regard to the number of teeth and the dimensions in such a way that the rotational angle of the steering wheel, in relation to the first gear mechanism element, is of substantially the same magnitude as the rotational angle of the module in the opposite direction. A rotation of the steering wheel in one direction therefore brings about a rotation of the module which is mounted on the steering wheel in the opposite direction relative to the steering wheel, to be precise by the same rotational angle, with the result that the angular position of the module which is mounted rotatably on the steering wheel remains constant in a fixed vehicle system of coordinates.

In one preferred embodiment of the invention, the first electrical contact unit is arranged in a manner which is mounted fixedly on the vehicle in the region of a hub of the steering wheel (for example, via its stator). For this purpose, the first contact unit can be configured, for example, in such a way that it can be plugged onto the hub of the steering wheel during assembly of the steering wheel and, as a result, is also connected to the steering wheel at the same time in the region of the hub, for example via its rotor (which can be rotated relative to the stator).

The second electrical contact unit is arranged on that side of the steering wheel basic body which lies opposite the hub of the steering wheel and faces the module, and is connected fixedly there to the module, for example via its stator. A rotor of the second contact unit is in turn connected fixedly in terms of rotation to the steering wheel.

The first electrical contact unit is advantageously connected electrically to the second electrical contact unit via a second opening in the steering wheel basic body of the steering wheel, to be precise, in particular, via an electrical plug-in connection between the stator and the rotor or via a flexible conductor. As a result of this, electrical elements which are arranged on the module, such as operating elements which can be operated by a vehicle driver in order to initiate different functions in the vehicle, can be connected electrically to the onboard electrical system of a motor vehicle. Furthermore, an ignition element can be provided, by way of which a gas generator of an airbag module can be ignited in order to inflate the airbag in the case of a crash.

### BRIEF DESCRIPTION OF THE DRAWINGS

Further details and advantages of the invention will be shown in the following text using figures, in which:

FIG. 1 shows an exploded illustration of a steering wheel having a device for mounting a module on the steering wheel;

FIG. 2 shows a cross section through a steering wheel according to FIG. 1;

FIG. 3 shows a perspective sectional illustration of a steering wheel according to FIG. 1; and

FIG. 4 shows a planetary gear mechanism, via which a module is mounted on the steering wheel.

### DETAILED DESCRIPTION OF THE PREFERRED EMBODIMENTS

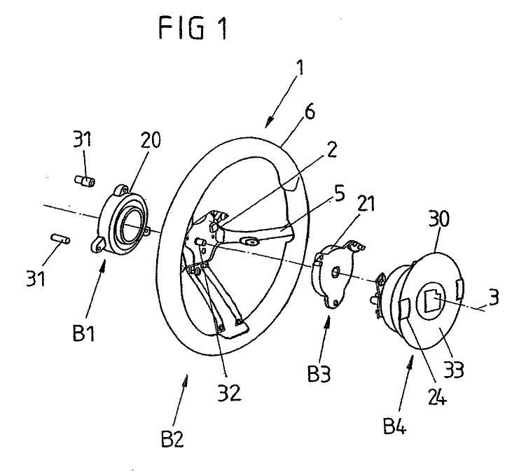

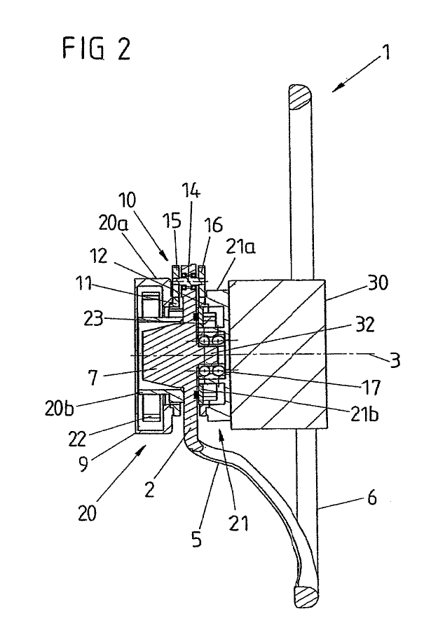

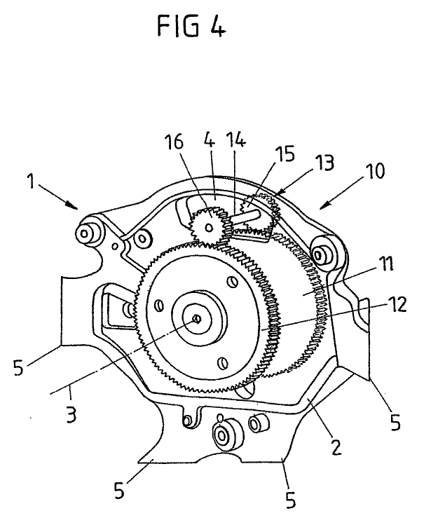

FIG. 1 shows an exploded illustration of a steering wheel 1 for a motor vehicle having a device for mounting a module 30 on the steering wheel 1, it being possible for the entire arrangement to comprise substantially four assemblies B1, B2, B3, B4. The latter will be described in greater detail in the following text with supplementary references to FIGS. 2 to 4.

A first assembly B1 comprises a first electrical contact unit 20, consisting of a first stator 20a, a first rotor 20b which can be rotated (about the steering axis) with respect to the latter, and a conductive film which is configured as a first flat spiral spring 22 and makes it possible to connect the rotor 20b electrically via the stator 20a to the electrical system of the motor vehicle. Furthermore, the first assembly B1 has a first central gearwheel 11 (sun gear) which is connected to the first stator 20a or is integrally formed on the latter and is part of a planetary gear mechanism 10 which serves as a reversing gear mechanism. Said first assembly B1 is connected by fastening means 31 via the first stator 20a to a motor vehicle part which is mounted fixedly on the vehicle, for instance to a housing 9 of the steering column or to the interior trim of the vehicle, as a result of which the first central gearwheel 11 is mounted fixedly on the vehicle.

A second assembly B2 comprises substantially the steering wheel 1 which has a steering wheel basic body in the form of a steering wheel base 2 which is connected to the steering wheel rim 6 via four spokes 5 which protrude from the steering wheel base 2. The first assembly B1 is connected to the steering wheel 1 via the first rotor 20b in the region of the hub 7, in that the first rotor 20b is attached fixedly in terms of rotation to the steering wheel 1. As a result, the steering wheel 1 can be rotated jointly with the first rotor 20b with respect to the stator 20a and the central gearwheel 11 of the first assembly B1.

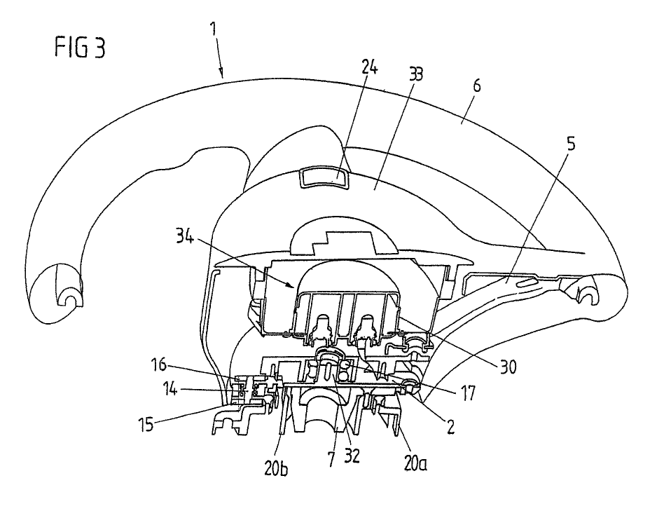

A third assembly B3 comprises a second electrical contact unit 21, consisting of a second stator 21a, a second rotor 21b which can be rotated (about the steering axis) with respect to the latter, and a conductive film which is configured as a second flat spiral spring 23 and connects the second rotor 21b electrically to the second stator 21a and thus makes it possible to connect the module 30 electrically to the electrical system of the motor vehicle. Furthermore, the third assembly B3 comprises a second central gearwheel 12 which is connected to the second stator 21a or is of integral configuration with the latter. By fitting the stator 21a of the third assembly B3 onto a journal or pin 32 which is formed on or fastened to the steering wheel base 2 of the steering wheel 1, said stator 21a is mounted rotatably on the steering wheel 1 by means of a ball bearing 17 which is arranged on the third assembly B3, whereas the second rotor 21b is connected fixedly in terms of rotation to the steering wheel 1. Here, FIG. 3 indicates, in a deviation from FIG. 2, that the journal or pin 32 can also be arranged on the second rotor 21b.

When the first, second and third assemblies B1, B2, B3 are joined together, the first and second flat spiral springs 22, 23 are connected to one another electrically via the two rotors 20b, 21b through a second opening in the steering wheel base 2 (for example, by means of an electrical line or by means of electrical plug-in elements). The third assembly B3 is thus connected to the electrical system of the motor vehicle via the first assembly B1.

A fourth assembly B4 has a module 30 in the form of an airbag module 30, the airbag of which can be inflated in order to protect the vehicle driver in the case of a crash. Said module 30 is connected fixedly in terms of rotation to the stator 21a of the second contact unit 21 by way of suitable fastening means. On the driver side, the fourth assembly B4 is covered by a cover 33, on which electrical operating elements 24 are arranged which can be actuated by the vehicle driver. Said electrical operating elements 24 are connected to the electrical system of the motor vehicle via the flat spiral springs 22, 23. An airbag device 34 having the airbag which can be inflated and deployed in the case of a crash is arranged below the cover 33 of the module 30.

When the above-described assemblies B1, B2, B3, B4 are fitted together, the first central gearwheel 11 (sun gear) which is arranged coaxially with respect to the steering axis 3 is coupled to the second central gearwheel 12 (sun gear) which is likewise arranged coaxially with respect to the steering axis 3 by means of a shaft 14 which is guided through a first opening 4 in the steering wheel base 2. This takes place via a first peripheral gearwheel 15 (planetary gear) which is arranged at a first end of the shaft 14 and engages into the first central gearwheel 11 of the first assembly B1, that is to say meshes with the latter. A second peripheral gearwheel 16 (planetary gear) which is arranged at the second end of the shaft 14 engages into the second central gearwheel 12 of the third assembly B3 and meshes with the latter. The first central gearwheel 11, the second central gearwheel 12, the first peripheral gearwheel 15 and the second peripheral gearwheel 16 thus form a planetary gear mechanism 10.

In order to increase the degree of integration further, that shaft 14 can also be arranged on the rotor 21b (which is connected to the steering wheel 1) of the second contact unit 21. An operative connection between the steering wheel 1 and the shaft 14 is critical in such a way that said shaft 14 is driven during a rotation of the steering wheel 1 and the first peripheral gearwheel 15 can roll on the associated central gearwheel 11.

As the first central gearwheel 11 of the first assembly B1 is arranged in a manner which is mounted fixedly on the vehicle, and the second central gearwheel 12 which is coupled to the first central gearwheel 11 via the peripheral gearwheels 15, 16 can be rotated together with the module 30 with respect to the steering wheel 1, a rotation of the steering wheel 1 which is performed by the vehicle driver can be converted into an opposite rotation of the module 30 of the fourth assembly B4, as will be shown in detail in the following text, that is to say the planetary gear mechanism acts as a reversing gear mechanism, by way of which a rotation of the steering wheel in a first direction can be converted into an opposite rotation of the module 30 with regard to the steering wheel 1.

In the following text, reference will be made, in particular, to the more detailed illustration of the above-described arrangement in FIGS. 2 to 4.

FIGS. 2 to 4 show, in greater detail, the rotatably mounted steering wheel 1 which has a steering wheel basic body in the form of a steering wheel base 2. Four spokes 5 which connect the steering wheel base 2 to a steering wheel rim 6 of the steering wheel 1 protrude from the steering wheel base 2.

The reversing gear mechanism is arranged on the steering wheel 1 in the form of a planetary gear mechanism 10 which has a first central gearwheel 11, a second central gearwheel 12, a first peripheral gearwheel 15 and a second peripheral gearwheel 16. The first central gearwheel 11 is arranged coaxially with respect to the steering axis 3 of the steering wheel 1 on the side of the hub 7 of the steering wheel base 2 in a manner which is mounted fixedly on the vehicle. The second central gearwheel 12 is likewise arranged coaxially with respect to the steering axis 3 of the steering wheel 1 on the module 30 on that side of the steering wheel base 2 which faces the vehicle driver. The first central gearwheel 11 is operatively connected to the second central gearwheel 12 via a shaft 14 which is guided through a first opening 4 in the steering wheel base 2 of the steering wheel 1 and extends parallel to the steering axis 3. The first peripheral gearwheel 15 which is arranged at the first end of the shaft 14 engages into the first central gearwheel 11, and the second peripheral gearwheel 16 which is arranged at the second end of the shaft 14 engages into the second central gearwheel 12, as a result of which the first central gearwheel 11 is coupled to the second central gearwheel 12.

The first central gearwheel 11 is connected fixedly in terms of rotation, together with the stator 20a of the first assembly B1, to a part of the motor vehicle which is mounted fixedly on the vehicle, in particular to a housing 9 of the steering column or a fitting of the motor vehicle. The second central gearwheel 12 is connected fixedly in terms of rotation, together with the stator 21a of the third assembly B3, to the module 30 which is mounted on the steering wheel 1 and can be rotated relative to the latter, that is to say the second central gearwheel 12 can be rotated jointly with said module 30.

If the steering wheel 1 is rotated, the shaft 14 which is guided through a first opening 4 in the steering wheel basic body 2 of the steering wheel 1 is driven in the rotational direction of the steering wheel 1, and the first peripheral gearwheel 15 rolls on the first central gearwheel 11 which is mounted fixedly on the vehicle. This rotational movement of the first peripheral gearwheel 15 is transmitted with an identical rotational direction to the second peripheral gearwheel 16 via the shaft 14. For its part, the rotation of the second peripheral gearwheel 16 is transmitted to the second central gearwheel 12 which meshes with it, with the result that the rotational movement of the second central gearwheel 12 is in the opposite direction to the rotational movement of the peripheral gearwheels 15, 16 and to the rotational movement of the steering wheel 1. As a result, the module 30 which is connected to the second central gearwheel 12 and is mounted on the steering wheel 1 such that it can rotate together with said second central gearwheel 12 is rotated in the opposite direction to the steering wheel 1, relative to the steering wheel 1, as a result of which the module 30 maintains a constant angular position during a rotational movement of the steering wheel 1, in relation to those parts of the motor vehicle which are mounted fixedly on the vehicle.

As the first central gearwheel 11 and the second central gearwheel 12 as well as the first peripheral gearwheel 14 and the second peripheral gearwheel 16 are configured so as to correspond to one another in each case in the embodiment of the invention shown, that is to say they have in each case the same diameter and, in particular, the same number of teeth, a 1:1 transmission takes place of the extent of the rotational movement of the steering wheel 1 to the second central gearwheel 12, with the result that the rotational angle which is passed through by the steering wheel 1 and by the module 30 relative to the steering wheel 1, in each case in the opposite direction, is substantially identical.

Furthermore, the steering arrangement which is shown in the figures has a first electric contact unit 20 having a first stator 20a, a first rotor 20b which can be rotated with respect to the latter, and a first flat spiral spring 22 which is formed by a conductive film and connects the stator 20a and the rotor 20b electrically, the first stator 20a being arranged, together with the first central gearwheel 11, on a part which is mounted fixedly on the vehicle and being connected fixedly to said part. A second electrical contact unit 21 comprises a second stator 21a, a second rotor 21b which can be rotated with respect to the latter, and a second flat spiral spring 23 which is formed by a conductive film and connects the stator 21a and the rotor 21b electrically. The second stator 21a is fixed on the module 30, together with the second central gearwheel 12, and is thus mounted such that it can be rotated with regard to the steering wheel basic body 2 of the steering wheel 1. The rotors 20b, 21b of both contact units 20, 21a re in each case attached fixedly in terms of rotation to the steering wheel 1, namely to its basic body 2.

Moreover, electrical connecting means are provided for connecting the first flat spiral spring 22 to the second flat spiral spring 23 electrically. Said connecting means comprise, for example, a plug-in connection or a flexible conductor which reaches through a second opening provided for this purpose in the steering wheel base 2 of the steering wheel 1 and connects the two rotors 20b, 21b to one another electrically. As a result, the operating elements 24 which are arranged on the module 30 for controlling different electrical functions in the vehicle can be connected to the electrical system of the vehicle.

Moreover, as long as the module is configured as an airbag module 30, a connection of an ignition element for a gas generator to the onboard electrical system of the vehicle can be produced via the flat spiral springs 22, 23, with the result that a crash sensor system can actuate the ignition element for igniting a gas generator in the case of a crash, in order to cause the airbag to inflate and deploy.

1. A device for mounting a module on a rotatable steering wheel of a motor vehicle in such a way that the angular position of the module remains constant if the steering wheel is rotated, the device comprising
a reversing gear mechanism,
a first gear mechanism element of the reversing gear mechanism which is fixed to a motor vehicle part which is mounted fixedly on the vehicle,
a second gear mechanism element of the reversing gear mechanism which is fixed to the module and can be rotated jointly with the module,
a gear mechanism assembly which can be actuated by rotation of the steering wheel and via which the first gear mechanism element is coupled to the second gear mechanism element in such a way that a rotation of the steering wheel relative to the first gear mechanism element in one direction is converted into a rotation of the module which is connected to the second gear mechanism element in the opposite direction with regard to the steering wheel,
a first electrical contact unit which is combined with the first gear mechanism element to form an assembly and is connected fixedly to the part which is mounted fixedly on the vehicle,
a second electrical contact unit which is combined with the second gear mechanism element to form an assembly and is connected fixedly to the module, and
electrical connecting means for connecting the first electrical contact unit to the second electrical contact unit.

2. The device as claimed in claim 1, characterized in that the first gear mechanism element and an element of the first electrical contact unit are fixed to a housing of the steering column or a part of the interior trim of the motor vehicle.

3. The device as claimed in claim 1, characterized in that the first gear mechanism element and an element of the first electrical contact unit are arranged in a manner which is mounted fixedly on the vehicle in the region of a hub of the steering wheel.

4. The device as claimed in claim 1, characterized in that the second gear mechanism element and an element of the second electrical contact unit are mounted on the module such that they can rotate with regard to the steering wheel.

5. The device as claimed in claim 1, characterized in that in each case one element of the first and the second electrical contact units is connected fixedly in terms of rotation to the steering wheel.

6. The device as claimed in claim 5, characterized in that that element of the first electrical contact unit which is connected fixedly in terms of rotation to the steering wheel is connected electrically via a flexible conductor to an element of the first electrical contact unit, which element is mounted fixedly on the vehicle, and in that that element of the second electrical contact unit which is connected fixedly in terms of rotation to the steering wheel is connected electrically via a flexible conductor to an element of the second electrical contact unit, which element is mounted fixedly on the module.

7. The device as claimed in claim 1, characterized in that either one or both of the first and the second electrical contact units has a stator, a rotor which can be rotated with respect to the stator, and a flexible conductor which connects the rotor to the stator electrically and can be wound up and unwound when the rotor is rotated with regard to the stator.

8. The device as claimed in claim 7, characterized in that the stator of the first electrical contact unit is arranged on the first gear mechanism element fixedly in terms of rotation with respect to the latter.

9. The device as claimed in claim 7, characterized in that the stator of the second electrical contact unit is arranged on the second gear mechanism element fixedly in terms of rotation with respect to the latter.

10. The device as claimed in claim 8, characterized in that the stator of either one or both of the first and second electrical contact units is integrally formed with the associated gear mechanism element.

11. The device as claimed in claim 7, characterized in that the rotor of either one or both of the first and the second electrical contact unit units is arranged fixedly in terms of rotation on the steering wheel.

12. The device as claimed in claim 1, characterized in that the first gear mechanism element and the second gear mechanism element are arranged coaxially with respect to a steering axis of the steering wheel.

13. The device as claimed in claim 1, characterized in that the reversing gear mechanism is configured as a planetary gear mechanism.

14. The device as claimed in claim 1, characterized in that the first gear mechanism element is configured as a first central gearwheel and the second gear mechanism element is configured as a second central gearwheel which is arranged coaxially with respect to said first central gearwheel.

15. The device as claimed in claim 1, characterized in that the gear mechanism assembly has a shaft which extends parallel to a steering axis of the steering wheel, for coupling the first gear mechanism element to the second gear mechanism element.

16. The device as claimed in claim 14, characterized in that the first central gearwheel is coupled to the second central gearwheel via a shaft which extends parallel to a steering axis of the steering wheel, a first peripheral gearwheel which is arranged on the shaft engaging into the first central gearwheel and a second peripheral gearwheel which is arranged on the shaft engaging into the second central gearwheel.

17. The device as claimed in claim 15, characterized in that the shaft for coupling the first gear mechanism element to the second gear mechanism element is guided through an opening in the steering wheel basic body of the steering wheel.

18. The device as claimed in claim 1, characterized in that the reversing gear mechanism is configured in such a way that, if the steering wheel is rotated by a defined rotational angle, the module which is mounted rotatably on the steering wheel is rotated by the same amount of angle relative to the steering wheel in the opposite direction, with the result that the angular position of the module remains constant with regard to the part which is mounted fixedly on the vehicle and the first gear mechanism element which is fixed to said part.

19. The device as claimed in claim 16, characterized in that the first and second central gearwheels and the first and second peripheral gearwheels in each case have the same number of teeth.

20. The device as claimed in claim 16, characterized in that the first and second central gearwheels and the first and second peripheral gearwheels in each case have the same diameter.

21. The device as claimed in claim 1, characterized in that the first electrical contact unit is connected electrically to the second electrical contact unit via an opening in a steering wheel basic body of the steering wheel.

22. The device as claimed in claim 1, characterized in that the first and second electrical contact units are connected to one another electrically via a plug-in connection.

23. The device as claimed in claim 1, characterized in that the module is configured as an airbag module which has an airbag which can be inflated in the case of a crash.

24. The device as claimed in claim 1, characterized in that electrical components are provided on the module in the form of operating elements which can be actuated by a vehicle driver or in the form of an ignition element for a gas generator, which electrical components can have electrical contact made with them by the second electrical contact unit.

25. The device as claimed in claim 1 in combination with the steering wheel for a motor vehicle, having a module which is arranged on the steering wheel, and having the device for mounting the module on the steering wheel.
